(19) United States
(12) Patent Application Publication
(10) Pub. No.: US 2015/0343637 A1
(43) Pub. Date: Dec. 3, 2015

(54) ROBOT, ROBOT SYSTEM, AND CONTROL METHOD

(71) Applicant: Seiko Epson Corporation, Tokyo (JP)

(72) Inventor: Yuki KIYOSAWA, Matsumoto (JP)

(21) Appl. No.: 14/727,047

(22) Filed: Jun. 1, 2015

(30) Foreign Application Priority Data
Jun. 2, 2014 (JP) 2014-114288

(51) Int. Cl. B25J 9/16; B25J 19/02

(52) U.S. Cl. CPC B25J 9/1679; B25J 9/1697; B25J 19/023; Y10S 901/02; Y10S 901/31; Y10S 901/47

(57) ABSTRACT

A robot includes: a hand which holds an object to be held; a manipulator having the hand; and a control unit which causes the manipulator to operate. The control unit moves the manipulator having the hand in the state of holding the object to be held, to a predetermined area, and causes the manipulator to detach a work member attached to the object to be held, from the object to be held.

### BACKGROUND

1. Technical Field

The present invention relates to a robot, a robot system, a control device and a control method.

2. Related Art

Research and development on causing a robot to carry out work using a tool is underway.

In connection with this, directly connecting an end effector as the tool to an arm of the robot is proposed (see JP-A-2012-35391).

However, the related-art robot cannot determine whether the supply of a work member by the robot is successful or not, and therefore cannot carry out an operation corresponding to the result of the determination. More specifically, in the related-art robot, for example, in the case of supplying a screw as a work member and tightening the supplied screw at a predetermined position with the tip of a screwdriver, even if whether the supply of the screw is successful or not is determined, and then it is determined that the screw is not properly supplied to the tip of the screwdriver, the screw may be left magnetically attached to the tip of the screwdriver and the magnetically attached screw may prevent re-supply of a screw.

### SUMMARY

An advantage of some aspects of the invention is that a robot, a robot system, a control device, and a control method that can realize an operation corresponding to the supply state of a work member are provided.

An aspect of the invention is directed to a robot including: a hand which holds an object to be held; a manipulator having the hand; and a control unit which causes the manipulator to operate. The control unit moves the manipulator having the hand in the state of holding the object to be held, to a predetermined area, and causes the manipulator to detach a work member attached to the object to be held, from the object to be held.

With this configuration, the robot moves the manipulator having the hand holding the object to be held, to a predetermined area, and causes the manipulator to detach the work member attached to the object to be held, from the object to be held. Thus, the robot can realize an operation corresponding to the supply state of the work member. More specifically, for example, if the object to be held and the work member are not in a desired supply state, the robot can start attachment work again. Moreover, if the work member is successfully supplied once but the work member is left on the object to be held in the subsequent work, the work member can be similarly detached from the object to be held.

In another aspect of the invention, in the robot, the control unit may cause the hand to operate so as to attach the work member to a tip of the object to be held, then determine whether the work member is attached in a predetermined state to the tip of the object to be held, and cause the hand to operate so as to detach the work member from the object to be held if it is not determined that the work member is attached in the predetermined state to the tip of the object to be held.

With this configuration, in the robot, the control unit causes the hand to operate so as to attach the work member to the tip of the object to be held, then determine whether the work member is attached in a predetermined state to the tip of the object to be held, and cause the hand to operate so as to detach the work member from the object to be held if it is not determined that the work member is attached in the predetermined state to the tip of the object to be held. Thus, the robot can realize an operation corresponding to the supply state of the work member. More specifically, for example, the robot can determine the attachment state between the object to be held and the work member and realize an operation corresponding to the supply state of the work member. If a desired supply state is not achieved, the robot can start attachment work again. Moreover, if the work member is successfully supplied once but the work member is left on the object to be held in the subsequent work, the work member can be similarly detached from the object to be held.

In another aspect of the invention, in the robot, the hand may include at least a first hand and a second hand. The control unit may cause the first hand to hold the object to be held and to attach the work member to the object to be held. If it is not determined that the work member is attached in a predetermined state to the tip of the object to be held, the control unit may cause the second hand to detach the work member from the object to be held.

With this configuration, the robot causes the first hand to hold the object to be held and to attach the work member to the object to be held. If it is not determined that the work member is attached in a predetermined state to the tip of the object to be held, the robot causes the second hand to detach the work member from the object to be held. Thus, the robot can remove the work member from the object to be held without having another configuration for removing the work member, even if the supply of the work member to the object to be held is unsuccessful.

In another aspect of the invention, in the robot, the work member may be detached from the object to be held, using a dedicated jig for detaching the work member from the object to be held.

With this configuration, the robot detaches the work member from the object to be held, using the dedicated jig for detaching the work member from the object to be held. Thus, the robot can securely detach the work member from the object to be held, with the dedicated jig for detaching the work member.

Still another aspect of the invention is directed to a robot system including: a robot having a hand which holds an object to be held, a manipulator having the hand, and a control unit which causes the manipulator to operate; and an image pickup unit which picks up a pickup image. The robot moves the manipulator having the hand in the state of holding the object to be held, to a predetermined area, and causes the manipulator to detach a work member attached to a tip of the object to be held, from the object to be held, on the basis of the image picked up by the image pickup unit.

With this configuration, in the robot system, the manipulator having the hand holding the object to be held is moved to a predetermined area, and the work member attached to the tip of the object to be held is detached from the object to be held, on the basis of the image picked up by the image pickup unit. Thus, the robot system can realize an operation corresponding to the supply state of the work member. More specifically, for example, the robot system can determine the attachment state between the object to be held and the work member, using the image pickup unit, and can realize an operation corresponding to the supply state of the work member. If a desired supply state is not achieved, the robot system can start attachment work again. Moreover, if the work member is successfully supplied once but the work member is left on the object to be held in the subsequent work, the work member can be similarly detached from the object to be held.

Yet another aspect of the invention is directed to a control device causing a robot to operate, the robot having a hand which holds an object to be held and a manipulator having the hand. The control device moves the manipulator having the hand in the state of holding the object to be held, to a predetermined area, and causes the manipulator to detach a work member attached to a tip of the object to be held, from the object to be held.

With this configuration, the control device moves the manipulator having the hand holding the object to be held, to a predetermined area, and causes the manipulator to detach the work member attached to the tip of the object to be held, from the object to be held. Thus, the control device can realize an operation corresponding to the supply state of the work member. More specifically, for example, the control device can determine the attachment state between the object to be held and the work member, and can control an operation corresponding to the supply state of the work member. If a desired supply state is not achieved, the control device can start attachment work again. Moreover, if the work member is successfully supplied once but the work member is left on the object to be held in the subsequent work, the work member can be similarly detached from the object to be held.

Still yet another aspect of the invention is directed to a control method for causing a robot to operate, the robot having a hand which holds an object to be held and a manipulator having the hand. The method includes moving the manipulator having the hand in the state of holding the object to be held, to a predetermined area, and causing the manipulator to detach a work member attached to a tip of the object to be held, from the object to be held.

With this configuration, in the control method, the manipulator having the hand holding the object to be held is moved to a predetermined area, and is made to detach the work member attached to the tip of the object to be held, from the object to be held. Thus, the control method can realize an operation corresponding to the supply state of the work member. More specifically, for example, in the control method, the attachment state between the object to be held and the work member can be determined and an operation corresponding to the supply state of the work member can be controlled. If a desired supply state is not achieved, attachment work can be started again. Moreover, if the work member is successfully supplied once but the work member is left on the object to be held in the subsequent work, the work member can be similarly detached from the object to be held.

According to the robot, the robot system, the control device and the control method described above, if the work member is successfully supplied once but the work member is left on the object to be held in the subsequent work, the work member can be similarly detached from the object to be held. Thus, the robot can realize an operation corresponding to the supply state of the work member. More specifically, for example, the robot can determine the attachment state between the object to be held and the work member, and can realize an operation corresponding to the supply state of the work member. If a desired supply state is not achieved, the robot can start attachment work again. Moreover, if the work member is successfully supplied once but the work member is left on the object to be held in the subsequent work, the work member can be similarly detached from the object to be held.

### BRIEF DESCRIPTION OF THE DRAWINGS

The invention will be described with reference to the accompanying drawings, wherein like numbers reference like elements.

FIG. 1 is a perspective view showing the outer configuration of a robot system 1 illustrated as an embodiment of the invention.

FIG. 2 is a block diagram showing the hardware configuration of a control device 30 in the robot system 1 illustrated as an embodiment of the invention.

FIG. 3 is a block diagram showing the functional configuration of a robot 20 and the control device 30 in the robot system 1 illustrated as an embodiment of the invention.

FIG. 4 is a flowchart showing operation procedures in the robot system 1 illustrated as an embodiment of the invention.

FIG. 5 is a side view for explaining the pickup of an image that covers a range including a tip SC of an electric screwdriver T in the robot system 1 illustrated as an embodiment of the invention.

FIGS. 6A to 6C are side views showing the relationship between the tip SC of the electric screwdriver T and a screw O in the robot system 1 illustrated as an embodiment of the invention. FIG. 6A shows a proper supply state. FIG. 6B shows an improper state. FIG, 6C shows an unattached state.

FIG. 7 is a side view showing the removal of the screw O attached to the tip SC of the electric screwdriver T, by another holding unit HND2, in the robot system 1 illustrated as an embodiment of the invention.

FIG. 8 is a side view showing the removal of the screw O attached to the tip SC of the electric screwdriver T, using a jig B, in the robot system 1 illustrated as an embodiment of the invention.

### DESCRIPTION OF EXEMPLARY EMBODIMENTS

### Embodiment

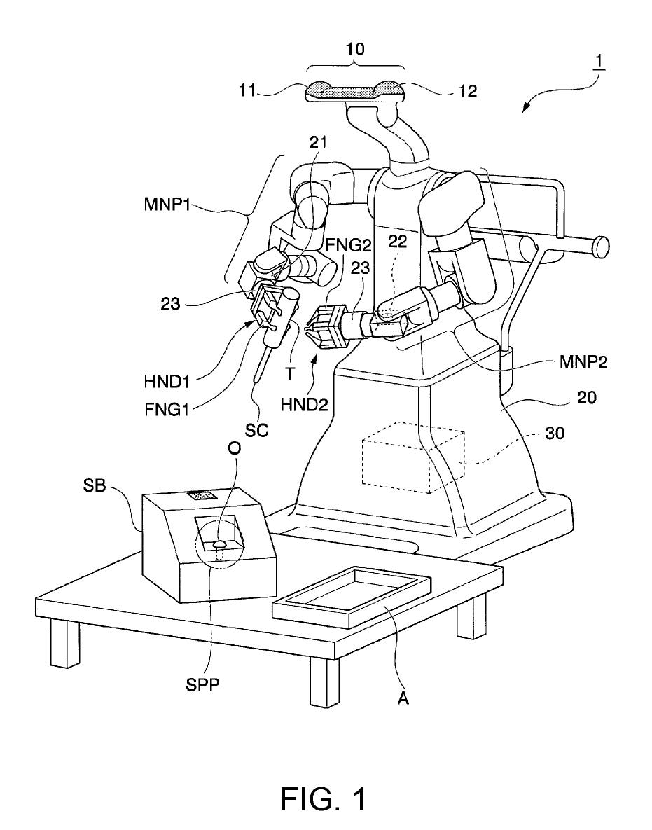

Hereinafter, an embodiment of the invention will be described with reference to the drawings. FIG. 1 shows the configuration of a robot system 1 according to the embodiment. The robot system 1 includes an image pickup unit 10, a robot 20, and a control device 30.

The robot 20 has a first moving image pickup unit 21, a second moving image pickup unit 22, a force sensor 23, a holding unit HND1 (first hand), a holding unit HND2 (second hand), a manipulator MNP1, and a manipulator MNP2. A plurality of actuators, not shown, is installed inside the holding units HND1, 2 and the manipulators MNP1, 2.

In the embodiment, the robot 20 is a double-arm robot.

A double-arm robot is a robot having two arms, that is an arm formed by the holding unit HND1, a claw portion FNG1 and the manipulator MNP1 (hereinafter referred to as a first arm), and an arm formed by the holding unit HND2, a claw portion FNG2 and the manipulator MNP2 (hereinafter referred to as a second arm). The holding units HND1 and the holding unit HND2 are attached to the tips of the manipulator MNP1 and the manipulator MNP2, respectively. The claw portions FNG1, 2, described below, are connected with the tips of the holding portions HND1, 2.

The invention is applicable not only to a double-arm robot but also to a single-arm robot. A single-arm robot is a robot having one arm, for example, a robot having one of the first arm and the second arm.

The robot 20 in the embodiment has the control device installed therein, and causes the control device 30 installed therein to perform control. As another configuration example, the robot 20 may cause an externally installed control device 30 to perform control, instead of having the control device 30 installed therein.

The first arm is a six-axis perpendicular multi-joint type. The manipulator MNP1, the holding unit HND1 and the claw portion FNG1 can perform operations with degrees of freedom on the six axes based on coordinated operations via the actuators. The first arm also has the first moving image pickup unit 21 and the force sensor 23.

The first moving image pickup unit 21 is, for example, a camera having a CCD (Charge Coupled Device) or CMOS (Complementary Metal Oxide Semiconductor), which is an image pickup element for converting condensed light to an electrical signal.

The first moving image pickup unit 21 is connected with the control device 30 via a cable in a way that enables communication. The wired communication via the cable is carried out, for example, according to a standard such as Ethernet (trademark registered) or USB (Universal Serial Bus). The first moving image pickup unit 21 and the control device 30 may also be connected together via wireless communication according to a communication standard such as Wi-Fi (trademark registered).

The first moving image pickup unit 21 is provided at a part of the manipulator MNP1 forming the first arm, as shown in FIG. 1, and can move with the movement of the first arm. The first moving image pickup unit 21 is arranged at a position where the first moving image pickup unit 21 can pick up a still image that covers a range including a screw O supplied to a tip SC of an electric screwdriver T in the state where the electric screwdriver T is held by the claw portion FNG2 of the holding unit HND2. Hereinafter, a pickup image picked up by the first moving image pickup unit 21 is referred to a first moving pickup image. While the first moving image pickup unit 21 is configured to pick up a still image that covers the above range as a first moving pickup image, the first moving image pickup unit 21 may instead be configured to pick up a dynamic image that covers the range as a first moving pickup image.

The force sensor 23 provided on the first arm is provided between the holding unit HND1 and the manipulator MNP1 of the first arm. The force sensor 23 detects a force or moment that acts on the holding unit HND1 (or the electric screwdriver T held by the holding unit HND1).

The force sensor 23 outputs information expressing the detected force or moment to the control device 30 via communication. The information expressing the force or moment detected by the force sensor 23 is used, for example, for compliant motion control of the robot 20 by the control device 30.

The second arm is a six-axis perpendicular multi-joint type. The manipulator MNP2 and the holding unit HND2 can perform operations with degrees of freedom on the six axes based on coordinated operations via the actuators. The second arm also has the second moving image pickup unit 22 and the force sensor 23.

The second moving image pickup unit 22 is, for example, a camera having a CCD or CMOS, which is an image pickup element for converting condensed light to an electrical signal.

The second moving image pickup unit 22 is connected with the control device 30 via a cable in a way that enables communication. The wired communication via the cable is carried out, for example, according to a standard such as Ethernet (trademark registered) or USB. The second moving image pickup unit 22 and the control device 30 may also be connected together via wireless communication according to a communication standard such as Wi-Fi (trademark registered).

The second moving image pickup unit 22 is arranged at a position where the second moving image pickup unit 22 can pick up a still image that covers a range including the screw O supplied to the tip SC of the electric screwdriver T in the state where the electric screwdriver T is held by the claw portion FNG1 of the holding unit HND1. Hereinafter, a pickup image picked up by the second moving image pickup unit 22 is referred to a second moving pickup image. While the second moving image pickup unit 22 is configured to pick up a still image that covers the above range as a second moving pickup image, the second moving image pickup unit 22 may instead be configured to pick up a dynamic image that covers the range as a second moving pickup image.

The force sensor 23 provided on the second arm is provided between the holding unit HND2 and the manipulator MNP2 of the second arm. The force sensor 23 detects a force or moment that acts on the holding unit HND2 (or the electric screwdriver T held by the holding unit HND2). The force sensor 23 outputs information expressing the detected force or moment to the control device 30 via communication. The information expressing the force or moment detected by the force sensor 23 is used, for example, for compliant motion control of the robot 20 by the control device 30.

Each of the first arm and the second arm may also be configured to operate with five degrees of freedom (five axes) or fewer, or may be configured to operate with seven degree of freedom (seven axes) or more. The holding unit HND1 and the holding unit HND2 of the robot 20 have a plurality of claw portions FNG1, 2 capable of holding an object between the claw portions. Thus, the robot 20 can hold the electric screwdriver T between the claw portions FNG of one or both of the holding unit HND1 and the holding unit HND2.

The image pickup unit 10 is a stereo image pickup unit which has a first fixed image pickup unit 11 and a second fixed image pickup unit 12 and which is configured with these two image pickup units. The image pickup unit 10 is not limited to the configuration with two image pickup units and may be configured with three or more image pickup units or may be configured to pick up a two-dimensional image with one image pickup unit.

In this embodiment, the image pickup unit 10 is installed at a top part as a part of the robot 20, as shown in FIG. 1. However, instead of this, the image pickup unit 10 may be configured to be installed at a different position from the robot 20, as a separate unit from the robot 20.

The first fixed image pickup unit 11 is, for example, a camera having a CCD or CMOS, which is an image pickup element for converting condensed light to an electrical signal. The first fixed image pickup unit 11 is connected with the control device 30 via a cable in a way that enables communication. The wired communication via the cable is carried out, for example, according to a standard such as Ethernet (trademark registered) or USB. The first fixed image pickup unit 11 and the control device 30 may also be connected together via wireless communication according to a communication standard such as Wi-Fi (trademark registered).

In this embodiment, the robot 20 includes a work area including a member supply device SB, within the image pickup range of the first fixed image pickup unit 11. Hereinafter, a pickup image picked up by the first fixed image pickup unit 11 is referred to as a first fixed pickup image.

While the first fixed image pickup unit 11 is configured to pick up a still image that covers the above range as a first fixed pickup image, the first fixed image pickup unit 11 may instead be configured to pick up a dynamic image that covers the range as a first fixed pickup image.

The second fixed image pickup unit 12 is, for example, a camera having a CCD or CMOS, which is an image pickup element for converting condensed light to an electrical signal. The second fixed image pickup unit 12 is connected with the control device 30 via a cable in a way that enables communication. The wired communication via the cable is carried out, for example, according to a standard such as Ethernet (trademark registered) or USB.

The second fixed image pickup unit 12 and the control device 30 may also be connected together via wireless communication according to a communication standard such as Wi-Fi (trademark registered).

The second fixed image pickup unit 12 is installed at a position where the second fixed image pickup unit 12 can pick up an image of a similar range to the first fixed image pickup unit 11. Hereinafter, a pickup image picked up by the second fixed image pickup unit 12 is referred to as a second fixed pickup image.

While the second fixed image pickup unit 12 is configured to pick up a still image that covers the above range as a second fixed pickup image, the second fixed image pickup unit 12 may instead be configured to pick up a dynamic image that covers the range as a second fixed pickup image.

Hereinafter, the first fixed pickup image and the second fixed pickup image are collectively referred to as stereo pickup images, as a matter of convenience for explanation.

The robot 20 is connected with the control device 30, for example, via a cable in a way that enables communication. The wired communication via the cable is carried out, for example, according to a standard such as Ethernet (trademark registered) or USB. The robot 20 and the control device 30 may also be connected together via wireless communication according to a communication standard such as Wi-Fi (trademark registered).

In the embodiment, the robot 20 acquires a control signal outputted from the control device 30 and has the operation thereof controlled on the basis of the acquired control signal. Thus, in the robot 20, the screw O is supplied from the member supply device SB by the electric screwdriver T held by the claw portion FNG1 of the holding unit HND1 of the robot 20. The action of supplying the screw to the tip SC of the electric screwdriver T means attaching the screw O to the tip SC of the electric screwdriver T. Specifically, the action of supplying the screw O to the tip SC of the electric screwdriver T includes any existing techniques that can be employed here, such as magnetically attaching the screw O to the tip SC of the electric screwdriver T, or sucking the screw O to the tip SC of the electric screwdriver T with air. In the embodiment, magnetically attaching the screw O to the tip SC of the electric screwdriver T is explained as an example.

If the supply of the screw O by the electric screwdriver T is unsuccessful, the robot 20 carries out an operation based on the supply error.

In the description below, an operation carried out by the first arm may be carried out by the second arm, and an operation carried out by the second arm may be carried out by the first arm. In other words, the robot 20 may be configured in such a way that the holding unit HND2 holds the electric screwdriver T, instead of the holding unit HND1 holding the electric screwdriver T. In this case, the operations carried out by the first arm and the second arm are switched in the description below.

Next, the control device 30 controlling the robot 20 will be described.

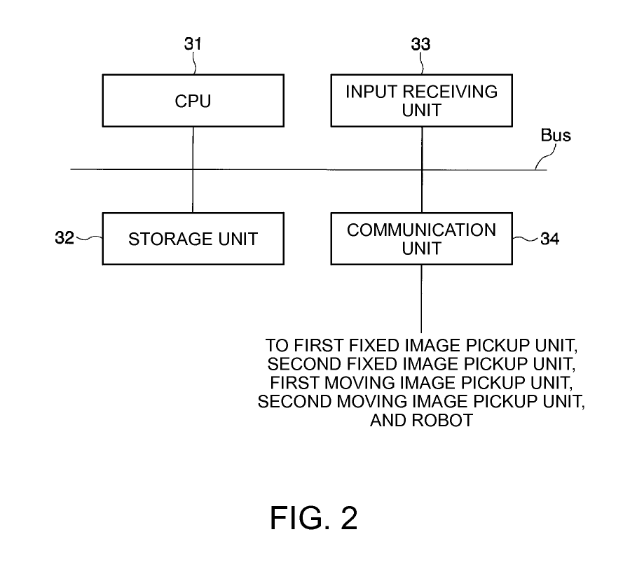

The control device 30 has, for example, the hardware configuration as shown in FIG. 2. The control device 30 has, for example, a CPU (Central Processing Unit) 31, a storage unit 32, an input receiving unit 33, and a communication unit 34. These components are connected together via a bus Bus in a way that enables communication.

The control device 30 communicates with the image pickup unit 10 and the robot 20 via the communication unit 34. The CPU 31 executes a robot control program stored in the storage unit 32. The control device 30 carries out processing according to the robot control program and thereby controls the robot 20 and the image pickup unit 10.

The storage unit 32 includes, for example, an HDD (Hard Disk Drive), SSD (Solid State Drive), EEPROM (Electrically Erasable Programmable Read-Only Memory), ROM (Read-Only Memory), RAM (Random Access Memory) or the like, and stores various kinds of information and images and the robot control program processed by the control device 30. The storage unit 32 may be an external storage device connected via a USB digital input/output port or the like, instead of the built-in storage unit in the control device 30.

The input receiving unit 33 is, for example, an input/output interface connected with a keyboard, mouse, touch pad, or other input devices (not shown). The input receiving unit 33 may function as a display unit and may also be configured as a touch panel.

The communication unit 34 includes, for example, a USB digital input/output port, Ethernet port or the like. The communication unit 34 outputs a control signal to each part of the robot 20 and inputs a sensor signal and image data from each part of the robot 20.

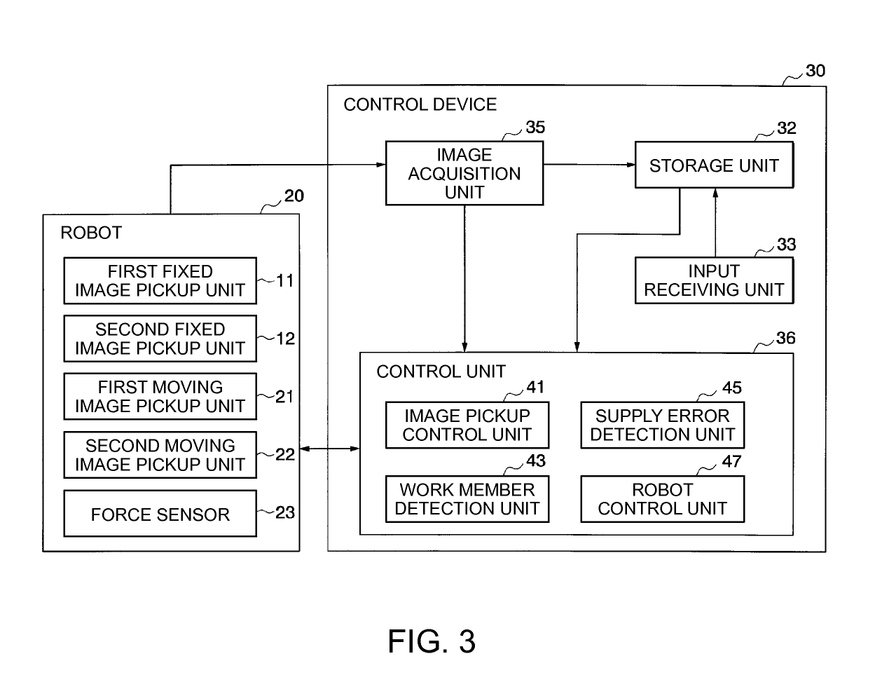

Next, the functional configuration of the control device 30 will be described with reference to FIG. 3. FIG. 3 shows the example of the functional configuration of the control device 30. The control device 30 has a control unit 36 as a functional configuration corresponding to the CPU 31. The control device 30 also has an image acquisition unit 35 as a functional configuration corresponding to the communication unit 34.

The image acquisition unit 35 acquires a stereo pickup image picked up by the image pickup unit 10. The image acquisition unit 35 outputs the acquired stereo pickup image to the control unit 36. The image acquisition unit 35 also acquires a first moving pickup image picked up by the first moving image pickup unit 21. The image acquisition unit 35 outputs the acquired first moving pickup image to the control unit 36. The image acquisition unit 35 also acquires a second moving pickup image picked up by the second moving image pickup unit 22. The image acquisition unit 35 outputs the acquired second moving pickup image to the control unit 36.

The control unit 36 includes an image pickup control unit 41, a work member detection unit 43, a supply error detection unit 45, and a robot control unit 47. A part or all of the functional units provided in the control unit 36 are realized, for example, by the CPU 31 executing the robot control program stored in the storage unit 32. Also, a part or all of the functional units may be hardware functional units such as LSI (Large Scale Integration) or ASIC (Application Specific Integrated Circuit).

The image pickup control unit 41 controls the image pickup unit 10 to pick up a stereo pickup image. More specifically, the image pickup control unit 41 controls the first fixed image pickup unit 11 to pick up a first fixed pickup image, and controls the second fixed image pickup unit 12 to pick up a second fixed pickup image. The image pickup control unit 41 also controls the first moving image pickup unit 21 to pick up a first moving pickup image. The image pickup control unit 41 also controls the second moving image pickup unit 22 to pick up a second moving pickup image.

The image pickup control unit 41 controls the image pickup operation of the first fixed image pickup unit 11 and the second fixed image pickup unit 12 of the image pickup unit 10, and of the first moving image pickup unit 21 and the second moving image pickup unit 22. For example, the image pickup control unit 41 controls the start of image pickup and the end of image pickup. The image pickup control unit 41 may also control zooming, image pickup direction and the like.

At the time of detecting a work member, the image pickup control unit 41 causes the image pickup unit 10 pick up a stereo pickup image. At the time of supply determination processing, the image pickup control unit 41 causes the first moving image pickup unit 21 and the second moving image pickup unit 22 to pick up images.

The work member detection unit 43 acquires the three-dimensional positional relation around the robot 20, referring to the stereo pickup image received from the image acquisition unit 35. Thus, the work member detection unit 43 detects the positions of the electric screwdriver T, the screw O, and the member supply device SB, as work members of the robot 20.

The work member detection unit 43 also reads screw position information which is information stored in the storage unit 32 and which expresses relative positions from the position of the member supply device SB to the screw O, and detects (calculates) the position of the screw O on the basis of the screw position information that is read.

Instead of the configuration to detect the position of the member supply device SB and detect the position of the screw O on the basis of the detected position of the member supply device SB, the work member detection unit 43 may be configured to detect the screw O from the stereo pickup image by pattern matching or the like without using the position of the member supply device SB. In this case, the work member detection unit 43 detects the position of the screw O from the stereo pickup image without grasping the position of the member supply device SB.

The robot control unit 47 supplies a control signal to the actuators that cause the manipulators MNP1, 2 and the holding units HND1, 2 to operate. This control signal includes the amount of operation of each actuator. In this case, the robot control unit 47 refers to the force or moment applied to the manipulators MNP1, 2 and the holding units HND1, 2 that is detected by the force sensor 23.

Thus, the robot control unit 47 controls the operations of the manipulators MNP1, 2 and the holding units HND1, 2 in the robot 20. Specifically, the robot control unit 47 controls the manipulators MNP1, 2 and the holding units HND1, 2 to hold the electric screwdriver T. Also, the robot control unit 47 controls the manipulators MNP1, 2 to supply the screw O to the tip SC of the electric screwdriver T. If the screw O is not supplied in a proper state to the tip SC of the electric screwdriver T, the robot control unit 47 causes the screw O to be removed from the tip SC of the electric screwdriver T. If the screw O is supplied properly to the tip SC of the electric screwdriver T, the robot control unit 47 controls the manipulators MNP1, 2 to tighten the screw O.

The proper state is, for example, a state where the tip SC of the electric screwdriver T is fitted in a recess provided on the screw head of the screw O and where a center axis extending in the longitudinal direction of the electric screwdriver T and a center axis extending in the direction in which the screw O advances by being tightened overlap with each other, thus enabling the screw O to be tightened by the electric screwdriver T. However, the proper state is not limited to this and may be some other states. The state following the supply of the screw O to the tip SC of the electric screwdriver T including the proper state is an example of a supply state. The proper state is an example of a predetermined state.

The supply error detection unit 45 carries out supply determination processing in which whether the screw O is supplied in the proper state to the electric screwdriver T or not is determined. At this time, the supply error detection unit 45 refers to the first moving pickup image or the second moving pickup image picked up by the first moving image pickup unit 21 or the second moving image pickup unit 22 and acquired by the image acquisition unit 35.

The supply error detection unit 45 matches, for example, the moving pickup image including the tip SC of the electric screwdriver T and the screw O, with a predetermined shape. This predetermined shape is image data expressing that the screw O is supplied in the proper state to the tip SC of the electric screwdriver T. If the moving pickup image matches with the predetermined shape or if the matching error is small, it is determined that the screw O is supplied in the proper state to the tip SC of the electric screwdriver T.

The result of the determination in the supply determination processing by the supply error detection unit 45 is supplied to the robot control unit 47. Thus, the robot control unit 47 can select the next operations of the manipulators MNP1, 2 and the holding units HND1, 2 according to the result of the determination.

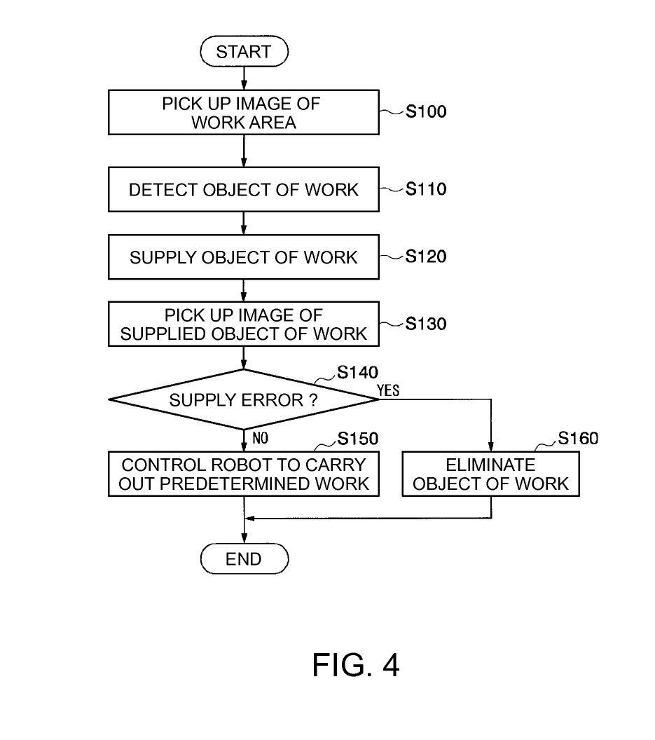

Next, the operation of the robot system 1 will be described with reference to the flowchart of FIG. 4 and FIGS. 5 to 8.

First, in Step S100, the robot system 1 picks up an image of the work area of the robot 20, with the image pickup unit 10. This work area includes the place to put the member supply device SB, the screw O, and the electric screwdriver T. The stereo pickup image picked up by the image pickup unit 10 is supplied to the control device 30.

In the subsequent Step S110, the robot system 1 detects the work members of the robot 20. At this time, the control device 30 analyzes the stereo pickup image picked up in Step S100 and detects the electric screwdriver T, the tip SC of the electric screwdriver T, the screw O, and the member supply device SB. Thus, the robot system 1 recognizes the positions of the work members in the space where the robot 20 operates.

In the subsequent Step S120, the robot system 1 supplies the screw O as a work member to the electric screwdriver T.

At this time, referring to stereo pickup images picked up by the first fixed image pickup unit 11 and the second fixed image pickup unit 12, the robot system 1 causes the manipulator MNP1 to operate and to hold the electric screwdriver T with the claw portion FNG at the tip of the holding unit HND1. Subsequently, referring to the stereo pickup images, the robot system 1 supplies the screw O (work member) from the member supply device SB, using the electric screwdriver T (object to be held) held by the robot 20.

In the embodiment, the tip of the electric screwdriver T is formed by a permanent magnet, and the screw O is metallic. The robot system 1 causes the manipulator MNP1 to operate and to move the tip SC of the electric screwdriver T toward the screw O. Thus, the screw O is magnetically attached to the tip SC of the electric screwdriver T by the magnetic force of the electric screwdriver T.

Every time the screw O is removed from a position SPP shown in FIG. 1, the member supply device SB arranges (supplies) the screw O stored therein to the position SPP.

In the subsequent Step 5130, after the screw O is supplied to the tip SC of the electric screwdriver T in Step S120, the robot system 1 picks up an image of the screw O as a work member supplied to the electric screwdriver T.

The robot system 1 picks up an image that covers a range including the tip SC of the electric screwdriver T, with the second moving image pickup unit 22. At this time, the robot system 1 causes the manipulator MNP1 to operate in such a way that the tip SC of the electric screwdriver T is located at a predetermined position. Meanwhile, the robot system 1 causes the manipulator MNP2 to operate in such a way that the tip SC of the electric screwdriver T is includes in the image pickup range of the second moving image pickup unit 22.

The robot system 1 causes the second moving image pickup unit 22 to pick up a second moving pickup image in the state where the tip SC of the electric screwdriver T is included in the image pickup range of the second moving image pickup unit 22. This second moving pickup image is supplied to the control device 30.

At this time, the control device 30 moves the electric screwdriver T having the screw O supplied to the tip SC thereof by the holding unit HND1, to a predetermined position.

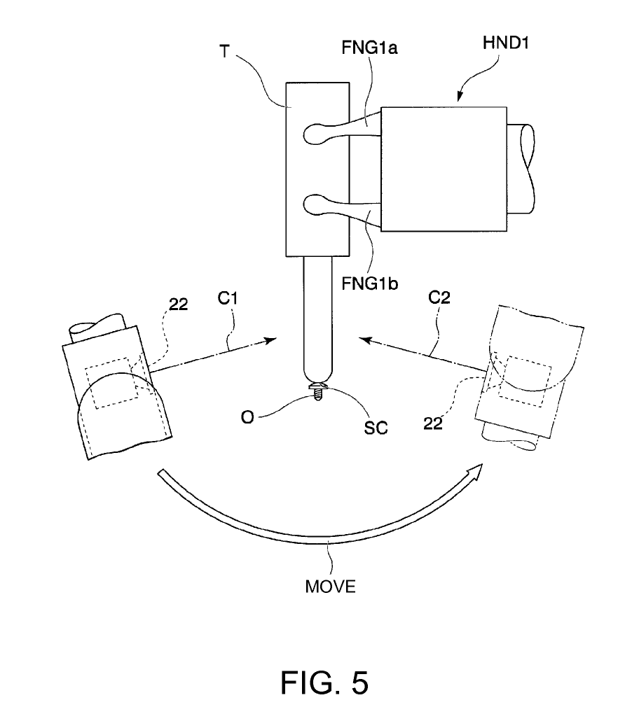

As shown in FIG. 5, the electric screwdriver T is held between the claw portions FNG including the claw portions FNG1a, 1b of the holding unit HND1. The holding unit HND1 has four claw portions FNG including claw portions FNG1a, 1b connected to the main body of the holding unit HND1. The distance between the tip of each of the claw portions FNG and the tip of the other claw portions FNG is adjustable by the actuator in the holding unit HND1. Thus, the electric screwdriver T is held between the claw portions FNG and stands still at a predetermined position.

In this state, the second moving image pickup unit 22 picks up an image that covers a range including the electric screwdriver T held by the holding unit HND1 and the screw O attached to the tip SC of the electric screwdriver T, from each of a first direction C1 and a second direction C2 that is different from the first direction C1.

At this time, the control device 30 first causes the second moving image pickup unit 22 to pick up an image of the screw O and the tip SC of the electric screwdriver T from the first direction C1, thus obtaining a second moving pickup image. Next, the control device 30 moves the second moving image pickup unit 22 as indicated by an arrow in FIG. 5 and causes the second moving image pickup unit 22 to pick up an image of the tip SC of the electric screwdriver T from the second direction C2. Thus, the control device 30 obtains a second moving pickup image picked up from the second direction C2.

In this embodiment, the holding unit HND1 holds the electric screwdriver T, and the second moving image pickup unit 22 on the holding unit HND2 is moved to pick up an image of the tip SC of the electric screwdriver T. However, it is possible to move the holding unit HND1, thus move the tip SC of the electric screwdriver T, and cause the second moving image pickup unit 22 to pick up an image.

In the subsequent Step S140, the control device 30 determines whether the screw O is attached in a predetermined state to the tip SC of the electric screwdriver T or not (supply error determination processing).

More specifically, the supply error detection unit 45 carries out pattern matching based on an image (image that is picked up, CG or the like) showing the state where the screw O is supplied in a proper state to the tip SC of the electric screwdriver T, from the storage unit 32, and thus determines whether there is a supply error. Whether the screw O is supplied in a proper state to the tip SC of the electric screwdriver T or not is determined, as a result of the determination based on the pattern matching using one of the first second moving pickup image and the second second moving pickup image. In the embodiment, the determination is carried out using one of the first second moving pickup image and the second second moving pickup image. However, the determination may be carried out using both of the first second moving pickup image and the second second moving pickup image.

If it cannot be determined that the screw O is attached in a predetermined state to the tip SC of the electric screwdriver T, it is determined that there is a supply error, and the processing goes to Step S160. If it is successfully determined that the screw O is attached in a predetermined state to the tip SC of the electric screwdriver T, the processing goes to Step S150.

This proper state (predetermined state) refers to, for example, the state where the tip SC of the electric screwdriver T and the screw head of the screw O fit with each other so that the screw O can be tightened by the operation of the electric screwdriver T, or the like. However, the proper state is not limited to this and may be any state where it is possible to continue the work using the screw O as a work member, holding the electric screwdriver T as an object to be held.

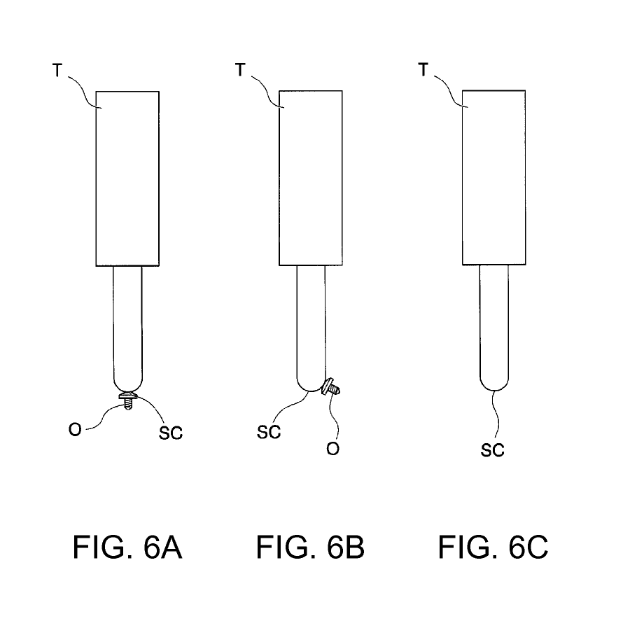

Specifically, the screw O can be supplied to the tip SC of the electric screwdriver T in various states as shown in FIGS. 6A to 6C.

FIG. 6A shows the state where the screw O is supplied in the proper state to the tip SC of the electric screwdriver T. In this state, the screw head of the screw O fits with the tip SC of the electric screwdriver T in a way that enables tightening of the screw O by the tip SC. More specifically, the state where the screw head fits with the tip in a way that enables tightening of the screw refers to the state where the screw head fits with the tip in such a way that the center axis in the longitudinal direction of the electric screwdriver T and the center axis according to the direction in which the screw O advances when tightened coincide with each other. In the case where the screw is supplied in the state as shown in FIG. 6A, the supply error determination processing results in negative determination.

FIG. 6B shows the state where it cannot be determined that the screw O is supplied in the proper state to the tip SC of the electric screwdriver T. The screw head of the screw O does not fit with the tip SC in a way that enables tightening of the screw by the tip SC of the electric screwdriver T. The center axis at the time of tightening the screw O does not coincide with the center axis in the longitudinal direction of the electric screwdriver T. The case where the screw is not in the proper state refers to the case where the screw O cannot be tightened by the electric screwdriver T, as in this example.

FIG. 6C shows the case where the screw O is not magnetically attached to the tip SC of the electric screwdriver T. In this state, the screw O is not supplied to the tip SC of the electric screwdriver T. This means that the supply of the screw O with the tip SC of the electric screwdriver T is unsuccessful.

In the states as shown in FIGS. 6B and 6C, the supply error determination processing results in positive determination. In the case of FIG. 6C, the process of removing the screw O in the subsequent Step S160 may be cancelled.

In the embodiment, the second moving pickup images picked up from the two directions are supplied to the control device 30. The control device 30 analyzes each of the second moving pickup images and determines whether the screw O is attached in the proper state to the electric screwdriver T or not. Since the two second moving pickup images are thus picked up from the two directions, that is, the first direction C1 and the second direction C2, the control device 30 can restrain a determination error in which the state having no supply error is regarded as the state having a supply error.

Also, the control device 30 may cause the second moving image pickup unit 22 to pick up second moving pickup images from three or more directions including the first direction C1 and the second direction C2. Moreover, the control device 30 may cause the second moving image pickup unit 22 to pick up a second moving pickup image from only one of the first direction C1 and the second direction C2.

Furthermore, the control device 30 may be configured to determine whether the screw O is supplied in the proper state to the tip SC of the electric screwdriver Tor not, on the basis of a stereo pickup image picked up by the image pickup unit 10.

In this case, the control device 30 causes the tip SC of the electric screwdriver T and the screw O to standstill in range that can be picked up by the image pickup unit 10. In this case, after the screw O is supplied by the tip SC of the electric screwdriver T, a range including the electric screwdriver T held by the holding unit HND1 and the screw O magnetically attached to the tip SC of the electric screwdriver T is defined as a position that can be picked up by the image pickup unit 10.

In Step S150, the robot system 1 controls the robot 20 to carry out predetermined work. As this predetermined work, the robot 20 is controlled to move the screw O supplied by the electric screwdriver T to a predetermined position and then tighten the screw O.

The control device 30 is configured to carry out operations such as supply of the screw O from the member supply device SB in away that does not break the member supply device SB or the screw O, and tightening of the screw O, for example, via visual servo and compliant motion control. Instead of this, the control device 30 may be configured not to carry out compliant motion control, or may be configured to control the robot 20 by some other methods than visual servo. One or both of the holding unit HND1 and the holding unit HND2 are an example of a hand.

In Step S160, the robot system 1 carries out an operation based on the supply error. The operation based on the supply error is an operation of moving the manipulator MNP having the holding unit HND holding the electric screwdriver T to a predetermined removal area (predetermined area) and removing the screw O attached to the electric screwdriver T, from the electric screwdriver T (removal). This removal area may be provided at an arbitrary position, excluding the place to put the member supply device SB and the screw O shown in FIG. 1 and the work area using the electric screwdriver T.

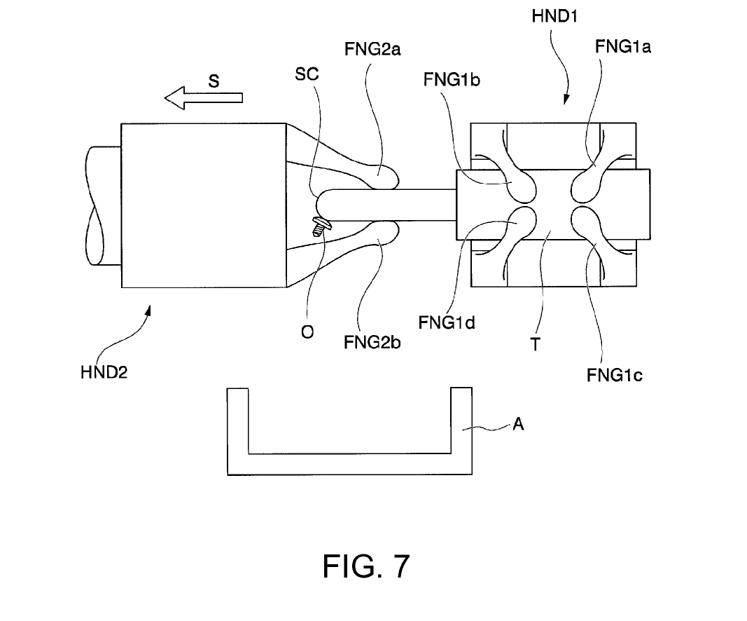

Specifically, the electric screwdriver T is held by the claw portions FNG1a to 1d of the holding unit HND1, and the screw O is removed from the tip SC of the electric screwdriver T by the claw portions FNG2a, 2b of the holding unit HND2, as shown in FIG. 7. In this case, first, the electric screwdriver T is situated above a removal area A. The holding unit HND2 holds, between the claw portions FNG2a, 2b, a bottom part of the metallic part attached to the main body of the electric screwdriver T. Next, the holding unit HND2 slides in a direction S in FIG. 7, toward the tip side of the tip SC of the electric screwdriver T. As the claw portions FNG2a, 2b thus reach the vicinity of the tip SC of the electric screwdriver T, the screw O can be removed from the electric screwdriver T by the force of the claw portions FNG2a, 2b.

The operations of the robot system 1 are described above with respect to the case of supplying the screw O to the electric screwdriver T. However, the operations of Step S100 and onward may be carried out also in the case where the screw O is left on the electric screwdriver T in the work after successful supply. Such a case may be where the screw O is left on the electric screwdriver T because tightening work is unsuccessful after successful supply.

If the robot system 1 is a single-arm robot, the screw O can be removed from the electric screwdriver T in other forms. For example, the electric screwdriver T may be vibrated to shake the screw O off the electric screwdriver T. Also, vibrating the electric screwdriver T to shake the screw O off the electric screwdriver T may be carried out in a double-arm robot as well.

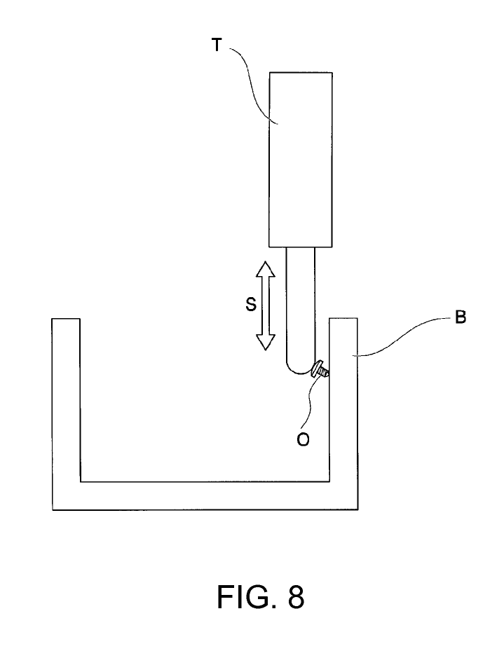

As another operation in Step S160, a dedicated jig B to remove the screw O from the tip SC of the electric screwdriver T may be used, as shown in FIG. 8. This jig B is, for example, a box-shaped bolded body, but this is not limiting.

If positive determination is made in Step S140, the control device 30 causes the manipulator MNP2 and the holding unit HND2 to operate so as to move the tip SC of the electric screwdriver T toward the jig B. Then, the control device 30 causes these components to abut the tip SC of the electric screwdriver T against the jig B, for example, in a direction S in FIG. 8. Thus, the screw O that is magnetically attached to the tip SC of the electric screwdriver T falls inside the jig B because of a frictional force between the screw O and the jig B.

Moreover, the removal of the screw O can be realized, for example, by the operation of pressing the screw O against the edge of the work table or the like, even without using the dedicated jig B.

In this Step S160, it is desirable that the control device 30 removes and drops the screw O in a different area from the area where the tightening of the screw is carried out in Step S150. Thus, the influence of the screw O falling from the tip SC of the electric screwdriver T, on the other work processes after the removal, can be restrained.

In Step S160, an image of the state following the removal of the screw O from the tip SC of the electric screwdriver T may be picked up. It is desirable that the control device 30 picks up an image of the tip SC of the electric screwdriver T following the end of the removal operation, from two or more viewpoints.

Thus, the control device 30 can determine whether the screw O is removed from the tip SC of the electric screwdriver T by the removal operation or not, on the basis of the pickup image. If it is determined that the screw O is removed from the tip SC of the electric screwdriver T, the operation can shift to newly supplying the screw O to the tip SC of the electric screwdriver T.

The robot system 1 is configured in such a way that the robot 20 holds the electric screwdriver T. However, instead of this, another tool (implement) that humans can use, or another tool dedicated for robot may be employed. The tool that humans can use may be, for example, a ratchet handle, wrench, or the like. If the tool is a ratchet handle, the member to be supplied is a ratchet socket or the like, instead of the screw O. If the tool is a wrench, the member to be supplied is a nut and bolt, or the like, instead of the screw O. Meanwhile, the tool dedicated for robot is an electric screwdriver provided as an end effector on the manipulator of the robot. The electric screwdriver T (that is, the tool) is an example of an object to be held. The screw O (that is, the member to be supplied) is an example of a work member.

As described above, according to the robot system 1, the robot 2, the control device 30, and the control method for the robot 20 of the embodiment, the manipulator MNP having the holding unit HND holding the electric screwdriver T is moved and thus the screw O attached to the electric screwdriver T can be removed from the electric screwdriver T.

With this configuration, the attachment state between the object to be held and the work member is determined and therefore the operation corresponding to the supply state of the work member can be realized. If a desirable supply state is not achieved, attachment work can be started again.

Also, according to the robot system 1, the robot 20, the control device 30, and the control method for the robot 20, the screw O can be similarly removed from the electric screwdriver T if the supply of the screw O to the tip SC of the electric screwdriver T is successful but the subsequent tightening of the screw is unsuccessful.

Moreover, according to the robot system 1, the electric screwdriver T can be held by one of the plurality of holding units HND, and the screw O at the tip SC of the electric screwdriver T can be removed by the other holding unit HND.

Thus, according to the robot system 1, even if the attachment of the screw O is unsuccessful, the screw O can be securely removed and the next work can be started. Also, according to the robot system 1, no other configurations to remove the screw O need to be provided.

Moreover, according to the robot system 1, the screw O can be removed from the tip SC of the electric screwdriver T by the jig B. Thus, according to the robot system 1, the screw O can be securely removed by the jig B dedicated for the removal of the screw O.

The mode for carrying out the invention is described above, using the embodiment. However, the invention is not limited to the embodiment and various modifications and replacements can be made without departing from the scope of the invention.

The entire disclosure of Japanese Patent Application No. 2014-114288, filed Jun. 2, 2014 is expressly incorporated by reference herein.

What is claimed is:

1. A robot comprising:
a hand which holds an object to be held;
a manipulator having the hand; and
a control unit which causes the manipulator to operate;
wherein the control unit
moves the manipulator having the hand in the state of holding the object to be held, to a predetermined area, and
causes the manipulator to detach a work member attached to the object to be held, from the object to be held.

2. The robot according to claim 1, wherein
the control unit
causes the hand to operate so as to attach the work member to a tip of the object to be held,
determines whether the work member is attached in a predetermined state to the tip of the object to be held, and
causes the hand to operate so as to detach the work member from the object to be held if it is not determined that the work member is attached in the predetermined state to the tip of the object to be held.

3. The robot according to claim 1, wherein
the hand includes at least a first hand and a second hand, and
the control unit
causes the first hand to hold the object to be held and to attach the work member to the object to be held, and
causes the second hand to detach the work member from the object to be held if it is not determined that the work member is attached in a predetermined state to a tip of the object to be held.

4. The robot according to claim 1, wherein the work member is detached from the object to be held, using a dedicated jig for detaching the work member from the object to be held.

5. A robot system comprising:
a robot having a hand which holds an object to be held, a manipulator having the hand, and a control unit which causes the manipulator to operate; and
an image pickup unit which picks up a pickup image;
wherein the robot moves the manipulator having the hand in the state of holding the object to be held, to a predetermined area, and causes the manipulator to detach a work member attached to a tip of the object to be held, from the object to be held, on the basis of the image picked up by the image pickup unit.

6. A control method for causing a robot to operate, the robot having a hand which holds an object to be held and a manipulator having the hand,
the method comprising moving the manipulator having the hand in the state of holding the object to be held, to a predetermined area, and causing the manipulator to detach a work member attached to a tip of the object to be held, from the object to be held.
